(19) United States
(12) Patent Application Publication
(10) Pub. No.: US 2013/0012177 A1
(43) Pub. Date: Jan. 10, 2013

(54) METHOD OF PROVIDING USER FRIENDLY SERVICES IN PORTABLE TERMINAL

(75) Inventor: Byung-Jik JEGAL, Goyang-si (KR)

(73) Assignee: Samsung Electronics Co., Ltd., Suwon-si (KR)

(21) Appl. No.: 13/535,999

(22) Filed: Jun. 28, 2012

(30) Foreign Application Priority Data
Jul. 4, 2011 (KR) 10-2011-0065990

(51) Int. Cl. H04W 4/00; H04W 4/02

(52) U.S. Cl. 455/414.2

(57) ABSTRACT

A method for providing a user friendly service in a portable terminal by acquiring an activity pattern of a user and acquiring environment information of a portable terminal; determining a service to be provided to the user through the acquired activity pattern of the user and the acquired environment information; and providing the user with the determined service.

### PRIORITY

This application claims priority under 35 U.S.C. §119(a) to a Korean Patent Application filed in the Korean Intellectual Property Office on Jul. 4, 2011 and assigned Serial No. 10-2011-0065990, the entire disclosure of which is incorporated herein by reference.

### BACKGROUND OF THE INVENTION

1. Field of the Invention

The present invention relates generally to provision of various useful services to a user in a portable terminal, and more particularly to provision of user friendly services appropriate for each user.

2. Description of the Related Art

Portable terminals, such as a smart phones and tablet PCs, provide a user with various useful functionality through a variety of applications. Therefore, the portable terminals are transforming into devices through which a user can use various types of information in addition to voice communication functionality.

As the functionality and utility of the portable terminals is increased, portable terminals are used more often. Accordingly, the portable terminals are closely involved in the daily life of users.

Therefore, if a portable terminal provides a user with services useful to the daily life of a user, a user may make better use of a portable terminal.

However, a conventional portable terminal provided only fragmentary services using a position of a portable terminal (or a user) for services related to life of a user, so that a user experienced inconvenience.

That is, a conventional portable terminal provides corresponding services by simply using position information through each application providing location based services, based on information on a current position of a portable terminal acquired by using a Global Positioning System (GPS) module, etc. However, without consideration of life patterns, preferences, or use environments (e.g. means of using transportation or a gender) of a user, a conventional portable terminal is not able to provide customized services in real time.

### SUMMARY OF THE INVENTION

Accordingly, the present invention has been made to solve the above-stated problems occurring in the prior art, and the present invention provides optimum services appropriate to a user of a portable terminal by considering an individual environment of the user of the portable terminal, to enable the user of the portable terminal to maximally use the portable terminal.

According to an aspect of the present invention, there is provided a method of providing a user friendly service in a portable terminal by acquiring an analyzed activity pattern of a user and acquiring environment information of a portable terminal; determining a service to be provided to the user through the acquired activity pattern of the user and the acquired environment information; and providing the user with the determined service.

Accordingly, the present invention analyzes a daily life pattern of a user and provides the user with customized services appropriate to the user depending on a given environment, thereby quickly providing the user with convenient services.

### BRIEF DESCRIPTION OF THE DRAWINGS

The above and other aspects, features and advantages of the present invention will be more apparent from the following description taken in conjunction with the accompanying drawings, in which:

FIG. 1 is a block diagram illustrating a portable terminal according to an embodiment of the present invention;

FIG. 2 is a flowchart illustrating provision of a user friendly service in a portable terminal according to an embodiment of the present invention;

FIGS. 3A and 3B are diagrams illustrating a first example of providing user friendly services in a portable terminal according to an embodiment of the present invention; and

FIG. 4 is a diagram illustrating a second example of providing a user friendly service in a portable terminal according to an embodiment of the present invention.

### DETAILED DESCRIPTION OF EMBODIMENTS OF THE PRESENT INVENTION

Embodiments of the present invention will be described in detail with reference to the accompanying drawings. In the following description, specific details such as detailed configuration and components are merely provided to assist in the overall understanding of the embodiments of the present invention. Therefore, it should be apparent to those of ordinary skill in the art that various changes and modifications of the embodiments described herein can be made without departing from the scope and spirit of the invention. In addition, descriptions of well-known functions and constructions are omitted for clarity and conciseness.

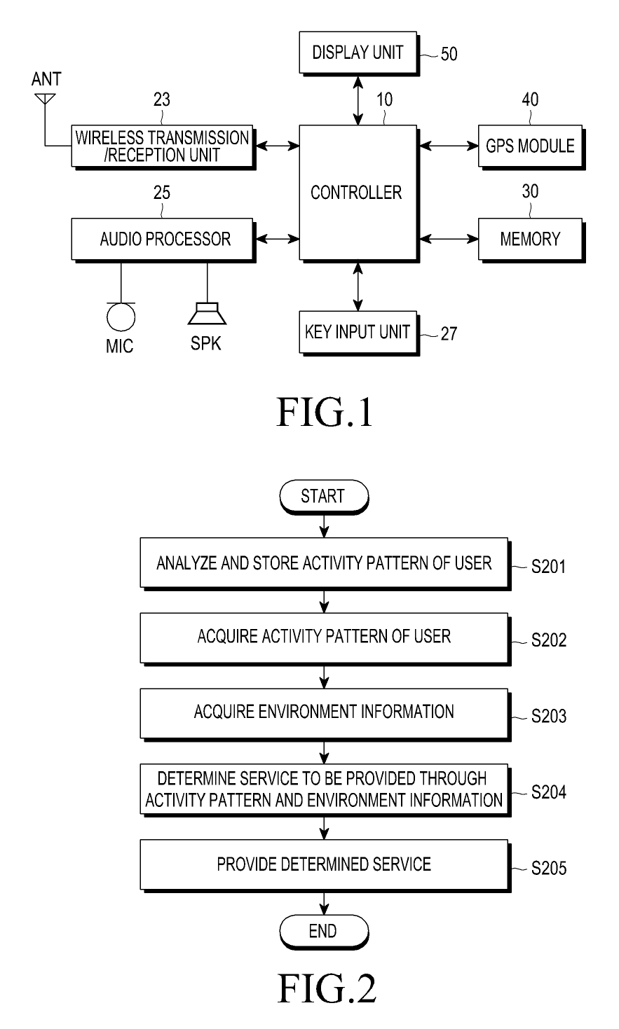

Embodiments of the present invention provide a portable terminal which is an easy-to-carry mobile electronic device such as a video phone, mobile phone, smart phone, International Mobile Telecommunication-2000 (IMT-2000) terminal, Wideband Code Division Multiple Access (WCDMA) terminal, Universal Mobile Telecommunication Service (UMTS) terminal, Personal Digital Assistant (PDAs), Portable Multimedia Player (PMPs), Digital Multimedia Broadcasting (DMB) terminal, E-Book reader, portable computer (notebook computer, tablet PC, etc.), or a digital camera. The portable terminal according to the embodiment of the present invention is described with reference to FIG. 1.

A wireless transmission/reception unit 23 includes a Radio Frequency (RF) unit and a modem. The RF unit includes an RF transmitter for up-converting and amplifying a frequency of a transmitted signal and an RF receiver for low-noise amplifying a received signal and down-converting a frequency. The modem includes a transmitter for encoding and modulating a signal to be transmitted and a receiver for demodulating and decoding a signal received from the RF unit.

An audio processor 25 may include a codec. The codec includes a data codec and an audio codec. The data codec processes packet data, and the like, and the audio codec processes a voice and audio signals of multimedia files, and the like.

The audio processor 25 performs a function of converting a digital audio signal received from the modem to an analog signal through the audio codec to reproduce the converted analog signal, or converting an analog audio signal generated from a microphone to a digital audio signal through the audio codec to transmit the converted digital audio signal to the modem. The codec may be separately produced from or included in a controller 10.

A key input unit 27 includes keys for inputting number and character information and function keys for setting various functions or a touch pad. When a display unit 50 is implemented in the form of an electrostatic or pressure sensitive touch screen, the key input unit 27 may include the preset minimum number of keys and the display unit 50 may partially substitute for the key input function of the key input unit 27.

A user may request to convert a display screen to a home screen through an input of a preset key (e.g. an input of a predetermined key through which a home screen is displayed) by using the key input unit 27 according to the embodiment of the present invention.

A memory 30 is configured with a program memory and a data memory. The program memory stores programs for controlling a general operation of the portable terminal. The memory 30 may further include an external memory, such as a Compact Flash (CF) memory, Secure Digital (SD) memory, Micro-SD memory, Mini-SD memory, Extreme Digital (xD) memory, and memory stick. Further, the memory 30 may include a disc, such as a Hard Disk Drive (HDD) and a Solid State Disk (SSD).

A movement route of the portable terminal may be stored in the memory 30 according to the embodiment of the present invention in a form of a database. However, whether to store the movement route of the portable terminal can be determined depending on privacy settings, set-up by a user.

A GPS module 40 receives a GPS signal and acquires a longitude value, a position value, and the like, corresponding to a current position of a portable terminal, to provide current position information of the portable terminal. The GPS module 40 may be substituted or used together with a separated hardware or software module capable of providing position information of the portable terminal. That is, a function of the GPS module 40 for providing position information on the portable terminal may be substituted or be used together with a position identification function using a triangulation method, and the like, through an inter-operation between the wireless transmission/reception unit 23 according to the embodiment of the present invention and base stations. Further, a position of the portable terminal may be acquired through a wireless network, such as a wireless Access Point (AP). In the following description, in order to more accurately identify a position of the portable terminal, the embodiment according to the present invention uses the GPS module 40 to identify the position information on the portable.

The display unit 50 may be configured with a Liquid Crystal Display (LCD) or an Organic Light Emitting Diode (OLED) display, (for example a Passive Matrix Organic Light Emitting Diode (PMOLED) display or Active Matrix Organic Light-Emitting Diode (AMOLED) display as an OLED display), and outputs various indication information generated in the portable terminal. The display unit 50 includes an electrostatic or pressure sensitive touch screen, so that it may serve as an input unit for controlling the portable terminal together with the key input unit 27.

The display unit 50 according to the embodiment of the present invention displays a screen on which icons are arranged. There may be one or more screens, and each screen may include various arranged content, such as folders, original multimedia files, or shortcuts depending on a necessity of a user, as well as icons corresponding to applications.

The display unit 50 according to the embodiment of the present invention displays a corresponding screen for each location (e.g. home, public transportation, or company) of the portable terminal and each screen may display a folder in which icons corresponding to the similar type of applications are grouped and stored.

The controller 10 controls a general operation of the portable terminal according to the embodiment of the present invention and may convert and control an operation of the portable terminal according to a user input through the key input unit 27 or the display unit 50. The controller 10 controls acquiring an analyzed activity pattern of a user and acquiring environment information on the portable terminal, determining a service to be provided to a user through the acquired activity pattern of the user and the acquired environment information, and providing a user with the determined service. The operation of the controller 10 is described in more detail below.

Although not illustrated in FIG. 1, the portable terminal according to the present invention may also include devices such as a Bluetooth® module, a camera module, a WiFi module, an acceleration sensor, a proximity sensor, a geomagnetic sensor, and a Digital Media Broadcasting (DMB) receiver, and it is apparent to those of ordinary skill in the art that such devices may be included in the portable terminal according to the embodiment of the present invention and provide corresponding functions.

The acceleration sensor measures dynamic power of acceleration, vibration, impact, etc. and senses a movement state of the portable terminal so that it may be used for sensing an indication direction of a display unit of the portable terminal based on the sensed movement state. Further, the proximity sensor senses proximity of a part of a body of a user to the portable terminal and it may be used for preventing a touch screen portable terminal from malfunctioning. The gyroscope observes a mechanical movement of a rotating portable terminal, and may be used for sensing a rotational motion with respect to six axes, i.e. up and down axis, left and right axis, front and rear axis, x-axis, y-axis, and z-axis, of the portable terminal through inter-operating with the acceleration sensor. Further, the camera module enabling a user to photograph an image (moving picture or still image) may be included in the portable terminal. Here, position information acquired using the GPS module 40 in photographing an image may be inserted in the photographed image and it is possible to identify the position where the user photographed the picture through the inserted position information.

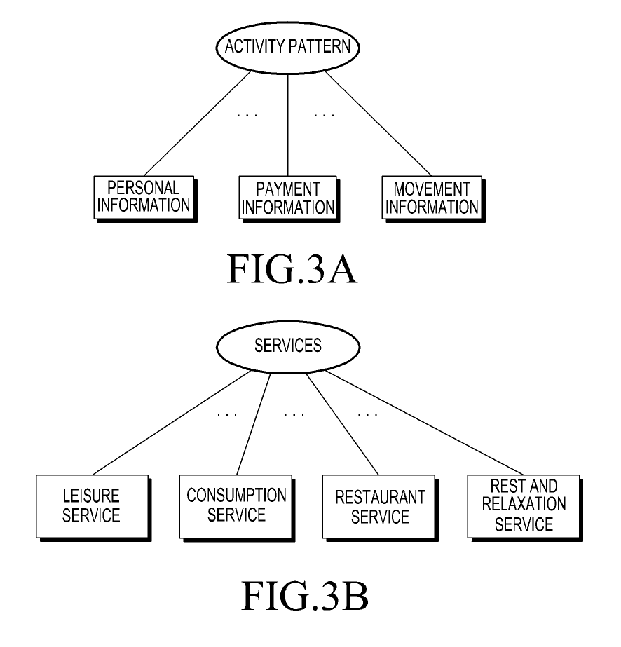

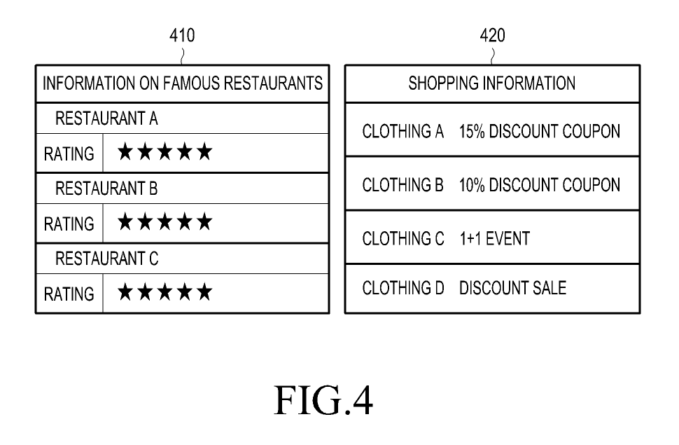

FIG. 2 is a flowchart illustrating provision of user friendly services in a portable terminal according to an embodiment of the present invention, FIGS. 3A and 3B are diagrams illustrating one example of providing user friendly services in a portable terminal according to an embodiment of the present invention, and FIG. 4 is a diagram illustrating another example of providing user friendly services in a portable terminal according to an embodiment of the present invention.

Referring to FIG. 2, in Step S201, the controller 10 makes a control command to analyze an activity pattern of a user and then the analyzed activity pattern of the user is stored.

According to an aspect of the present invention, activity patterns of a user are analyzed to provide the user with a user friendly service based on the analyzed activity patterns. Accordingly, the controller 10 makes a control command so that an activity pattern of a user is analyzed based on data (e.g. personal information, payment information, movement information, etc.) acquired at predetermined time intervals and the analyzed activity pattern is stored for later use.

The activity pattern of the user is analyzed through analyzing the data, such as personal information, movement information, payment information, etc. as shown in FIG. 3A. The personal information includes information on a personal identity of a user, the movement information includes information on a movement route of a user holding a portable terminal and transportation means used by a user holding a portable terminal, and the payment information includes information on user's consumption expenditure details.

Personal information is information on a personal identity of a user of the portable terminal and includes information on a name, gender, age, job, birthplace, schools, annual income, hobby, religion, etc. Through the personal information, it is possible to distinguish a user of the portable terminal from a user of another portable terminal.

Further, the movement information includes information on a movement route of a user (the a portable terminal) acquired through the GPS module 40, and the like, and information on a transportation means (e.g. public transportation, car, ship, train, or airplane) used for movement by a user. Through the movement information, the controller 10 may identify the places where the user was positioned for each time and identify the transportation means which the user used for traveling to a place.

The information on the transportation means used by the user may be directly input by the user, but also may be identified from analyzing the payment details (e.g. the price to use the subway or the price to use the bus) included in the payment information, described below.

Further, the payment information includes payment details received by e-mail and a text message, such as a Short Message Service (SMS), an Enhanced Messaging Service (EMS), a Multimedia Messaging Service (MMS), and the like, payment details acquired through access to a certain shopping web sites, payment details received and acquired from one or more credit card companies, and payment details acquired through an application enabling a user to identify payment details. The payment information includes information on a price paid for a purchase, amount of money of a user and information on a purchased object. Through payment information, it is possible to recognize a type of expenditure (or consumption pattern) generated for each position of a user and for each time.

For example, when a user spends a certain amount of money for eating out at place “Ka,” spent a certain amount of money for shopping at place “Na,” and spent a certain amount of money for a leisure activity (e.g. scuba diving) at place “Da,” it is possible to identify a consumption pattern and the position where the consumption occurred through the identification of the payment information.

Further, as described above, when information related to movement (e.g. a position, a time, a fee of using the bus) are included in the payment details contained in the payment information, it is possible to identify information on the transportation means used by the user through the payment information. That is, the payment information may be used for acquiring information on a transportation means used by a user for movement to a certain place and then the type of consumption of money expenditure of a user.

Although it is assumed that the activity pattern of the user after the analysis of the activity pattern is stored in the memory 30, it also may be stored in a separate external device (e.g. an external server) and acquired upon a request whenever necessary. Further, the personal information, the payment information, and the movement information for the analysis of the activity pattern of the user according to the embodiment of the present invention are collected (acquired) for a predetermined period of time and renewed in order to provide user friendly services. The period of time for collecting the activity pattern may be modified.

In Step S202, the controller 10 makes a control command to acquire an activity pattern of a user of the portable terminal, wherein the activity pattern has been analyzed for a predetermined period of time and renewed. The activity pattern of the user may be stored in a storage space (e.g. a memory) within the portable terminal or stored in a separate external device (e.g. an external server). For example, the controller 10 according to the embodiment of the present invention makes a control command to analyze the activity pattern of the user for a predetermined period of time and renewed, and then the analyzed activity pattern is configured in a form of a database, the database is stored in the memory 30 or is transmitted to an external server, and the activity pattern stored in the memory 30 or the external server is acquired, where necessary.

In Step S203, the controller 10 makes a control command so that environment information is acquired.

The environment information is acquired at a time (or a directly previous time) for providing a user friendly service and is referred to for the provision of the user friendly service. The environment information includes data on a current position of a portable terminal, the present time, weather information, a transportation means being used by the user, and navigation information of an area neighboring a current position, and is acquired in order to provide a service appropriate (user friendly) for a current situation of the user of the portable terminal.

The environment information may be acquired through the GPS module 40, information from a base station (not shown), or a predetermined application, and also may be input by a user.

In Steps S204 and 205, the controller 10 makes a control command so that a service to be appropriately provided to the user is determined through the activity pattern and the environment information and the service determined to be appropriate for the user is provided to the user.

When the activity pattern of the user analyzed for the predetermined period of time and the environment information are acquired through the previous Steps S202 and S203, the controller 10 makes a control command so that a user friendly service (e.g. a service appropriate to the user) to be provided to the user is determined based on the acquired activity pattern of the user and environment information and then a corresponding service is provided to the user through the display unit 50.

The service (e.g. a user friendly service) appropriately provided for each user of the portable terminal according to the embodiment of the present invention includes the type of services, such as a leisure service, a consumption service, a restaurant service, and a rest and relaxation service and other various types of services may be included. The leisure service may be a service provided where a usual movement route and consumption pattern of the user were identified to be related to several hobbies (e.g. scuba diving in Jeju Island) through a life pattern (especially, the movement information and the payment information) of the user and a weather information and a place are identified to be corresponding to a weather information and a place appropriate to a usually enjoying hobby of the user through the environment information. For example, a place related to a user hobby (e.g. fishing) is identified around a current position of the user through the activity pattern of the user and the environment information, the controller 10 makes a control command so that information (e.g. information on a fishing place) related to the hobby is displayed through the display unit 50, serving as the leisure service.

The consumption service may be a service provided where a usual movement route and consumption pattern of the user were identified to be related to shopping through a life pattern (especially, the personal information, the movement information, and the payment information) of the user and it is identified that the user is located at a place appropriate for purchasing an item included in a purchase list of usual shopping through the environment information. For example, when information on the lowest price or a discount coupon of a product which will attract an interest of the user is provided, the controller 10 makes a control command so that information on the product is provided to the user serving as the consumption service. Referring to FIG. 4, for example, as indicated by reference number 420 in FIG. 4, the controller 10 may provide the user with shopping information of an event being held at a position around the user.

The restaurant service may be a service provided where a usual movement route and consumption pattern of the user were identified to be related to consumption at restaurants including famous restaurants through a life pattern (especially, the movement information and the payment information) of the user and it is identified that a famous restaurant is located around a current position of the user through the environment information. Referring to FIG. 4, for example, as indicated by reference number 410 in FIG. 4, the controller 10 may provide the user with evaluation information, contact information (not shown), and location (not shown) on famous restaurants located around a current position of the user.

The rest and relaxation service may be a service provided where a usual movement route and consumption pattern of the user were identified to be related to expenditure at places related to a rest and relaxation activity, such as a spa and a massage center, through a life pattern (especially, the movement information and the payment information) of the user, and it is identified that a rest and relaxation-related place is located around a current position of the user through the environment information. For example, the controller 10 may provide the user with information related to a rest and relaxation activity of the user, and, for example, information related to skin care is displayed on the display unit 50 serving as the rest and relaxation service.

When the user friendly service, such as the leisure service, the consumption service, the restaurant service, and the rest and relaxation service, is displayed on the display unit 50, the user friendly service may be displayed on an entire region or a predetermined partial region (e.g. as a widget) of the display unit 50. Further, when a predetermined application is being executed, the user friendly service also may be displayed by being overlaid in a form of a pop-up window.

While the present invention has been shown and described in detail with reference to embodiments thereof, it will be understood by those of ordinary skill in the art that various changes in form and detail may be made therein without departing from the spirit and scope of the invention as defined by the appended claims.

What is claimed is:

1. A method of providing a user friendly service in a portable terminal, the method comprising:
acquiring an activity pattern of a user and acquiring environment information of a portable terminal;
determining a service to be provided to the user through the acquired activity pattern of the user and the acquired environment information; and
providing the user with the determined service.

2. The method as claimed in claim 1, wherein determining the service to be provided to the user comprises:
identifying appropriate services to be provided to the user through the activity pattern of the user; and
determining a service corresponding to a current position of the portable terminal among the identified services as a service to be provided to the user through the environment information.

3. The method as claimed in claim 1, wherein the acquired environment information of the portable terminal includes a current position of the portable terminal, a present time information, a weather information, a type of transportation means used, and a navigation information for an area neighboring the current position.

4. The method as claimed in claim 1, wherein the activity pattern of the user is analyzed based on personal information, payment information, and movement information of the user.

5. The method as claimed in claim 4, wherein the personal information includes information through which the user of the portable terminal is distinguished from a user of another portable terminal.

6. The method as claimed in claim 4, wherein the payment information includes payment details of the user of the portable terminal so that a consumption pattern of the user for each position and for each time is identified.

7. The method as claimed in claim 4, wherein the movement information of the user includes information on a time-based movement route and a transportation means used.

8. The method as claimed in claim 1, wherein the activity pattern of the user is stored in the portable terminal.

9. The method as claimed in claim 1, wherein the determined service includes a leisure service, a consumption service, a restaurant service, and a rest and relaxation service.

10. The method as claimed in claim 1, wherein the activity pattern of the user is stored in an external server.
